(19) United States
(12) Patent Application Publication
(10) Pub. No.: US 2026/0268878 A1
(43) Pub. Date: Sep. 10, 2026

(54) Hands-Free Music Instrument Support System

(71) Applicant: Nagesh Challa, Saratoga, CA (US)

(72) Inventor: Nagesh Challa, Saratoga, CA (US)

(21) Appl. No.: 19/072,584

(22) Filed: Mar. 6, 2025

(51) Int. Cl. G10G 5/00; G10D 1/02

(52) U.S. Cl. CPC G10G 5/005; G10D 1/02

(57) ABSTRACT

An apparatus and method for supporting a music instrument for playing, wherein a frame securely attaches to the instrument's body and connects to a stand via a connector. The frame may include adjustable arms connected by a joint or multiple feet that grip different points on the instrument, accommodating various instrument sizes and configurations. The stand, which can be a tripod, a monopod with foldable feet, or a flexible arm attached to a music stand, is coupled to the frame using connectors such as a shoe and plate combination, a ball head, or an integrated connector. This configuration balances the center of gravity of the music instrument, frame, and connector, positioning the instrument for comfortable playing without requiring support from a player's shoulder or chin or neck.

### BACKGROUND OF THE INVENTION

Throughout recent years, there has been a growing interest in enhancing the performance environment for musicians by exploring innovative support systems that reduce physical constraints during play. This interest emerged as part of a broader trend in ergonomics and assistive technology, reflecting an evolving understanding of how integrated design and subtly embedded control technologies can contribute to a more fluid musical experience. Such advancements have been influenced by developments in sensor technology and user-centered design principles, underscoring a journey toward creating alternatives that allow musicians to interact with their instruments more naturally and efficiently.

### SUMMARY OF THE INVENTION

In one aspect, a method of supporting a music instrument for playing includes attaching a frame to a body of the music instrument; connecting the frame to a stand; and adjusting the stand to position the music instrument for playing without requiring support from a player's shoulder or chin or neck.

The Frame can be used by itself, so that a user can purchase the Frame and add a standard Connector and Stand (these are standard camera accessories) to benefit from the system.

The Frame and the Connector can be used together so they can connect to a tripod and benefit from the system as well.

In another aspect, an apparatus for supporting a music instrument includes a frame configured to attach to a body of the music instrument; a stand; and a connector coupling the frame to the stand, wherein the frame, stand, and connector are arranged to position the music instrument for playing without requiring support from a player's shoulder or chin.

In other aspects, a method for supporting a musical instrument involves attaching a frame to the instrument's body. In another aspect, the frame is connected to a stand. In yet another aspect, the stand is adjusted to position the instrument for playing without needing support from a player's shoulder or chin.

In another aspect, an apparatus for supporting a music instrument is provided. The apparatus includes a frame configured to attach to the instrument's body, a stand, and a connector that couples the frame to the stand. In one embodiment, these components are arranged to position the instrument for playing without requiring support from a player's shoulder or chin.

Advantages may include one or more of the following:
Enhanced Ergonomics: The apparatus positions the musical instrument in an optimal playing orientation, reducing the need for a player to support the instrument on their shoulder or chin. This ergonomic improvement can help minimize strain and fatigue during prolonged use.
Reduced Risk of Musculoskeletal Injury: By eliminating the need to hold the instrument in traditionally awkward positions, one implementation may decrease the likelihood of repetitive strain injuries, resulting in improved long-term physical comfort and health for musicians.
Improved Instrument Stability: The secure connection between the frame, instrument body, and stand provides enhanced stability. This stability can allow performers to focus more on their technique and performance rather than on balancing the instrument.
Ease of Adjustment and Customization: The adjustable stand and connector system allow for customizable positioning that can be tailored to the unique playing style and anatomical considerations of individual musicians. This versatility can enhance the playing experience across a diverse range of users.
Increased Performance Freedom: With the instrument securely supported by the apparatus, a musician may experience greater freedom of movement. This can open up new possibilities for performance gestures and techniques that were previously constrained by traditional support methods.
Integration with Existing Instruments: Designed to attach directly to the instrument's body without compromising its acoustical properties or aesthetics, the apparatus can be retrofitted to many instruments, providing an adaptable solution that integrates seamlessly with existing musical equipment.
Potential for Enhanced Artistic Expression: By reducing physical limitations and allowing for a more natural posture, one implementation may contribute to a more fluid and expressive performance, empowering musicians to fully explore the creative potential of their instruments.

These advantages suggest that one implementation not only addresses ergonomic challenges but also enhances overall performance dynamics, potentially leading to broader adoption in scenarios where traditional instrument support methods limit musical expression and comfort.

### BRIEF DESCRIPTION OF DRAWINGS

The embodiments herein will be better understood from the following detailed description with reference to the drawings, in which:

FIG. 1 illustrates general block diagram of the Violin Stand.

FIG. 2 is a detailed block diagram of the Violin Stand's Frame including the various parts according to an embodiment herein;

FIG. 3 is a detailed diagram of the Violin Stand when configured to clip on to any type of Stand such as a Music Stand while FIG. 4 shows a top view of the frame.

### DETAILED DESCRIPTION OF THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

The embodiments herein disclose methods and systems that allow for creating a system to hold a Violin in place in a stable manner while being played and without placing the usual strain on the neck and shoulder. At the same time, the method used to hold the violin must have no more than a minimal impact on the acoustics of the Violin and must be adjustable to suit the height and playing style of the violinist. In addition, the apparatus can be made available in a portable form.

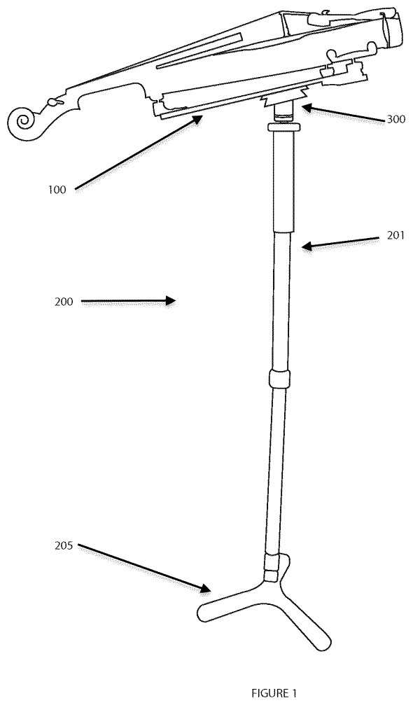

Next, the system is detailed when viewing FIGS. 1-4 in combination. In an embodiment herein, the Violin Stand shown in FIG. 1, is made up of three basic parts: 1. A Frame [100] that holds the violin securely; 2. A Stand [200] that can be placed on the floor and is stable and also strong enough to support the violin held by the frame; and 3. A Connector [300] that attaches the Frame [100] to the Stand [200].

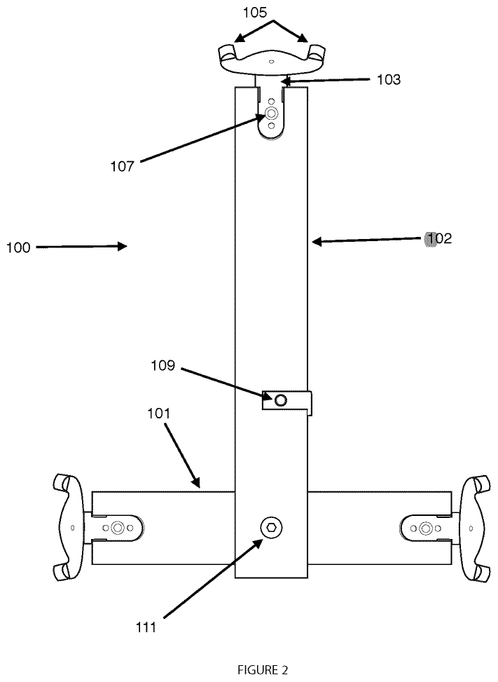

The Frame [100] is made of a rigid and lightweight material with reasonable strength—this could be plastic, wood or a suitable material. The Frame can be a modified shoulder rest available in the market currently. As shown in FIG. 2, the Frame [100] can be one piece or can consist of two Arms [101&102] with a Joint [111] around which the Arms can rotate or pivot. The Arms [101] and [102] of the Frame [100] can be a T-shaped structure as shown in FIG. 2. At the end of each Arm, End Members [103] are attached with screws [107] or other suitable means and each End Member [103] has a Gripper or Feet [105] that are typically used on Violin Shoulder rests that are currently available. Different types of Feet and different types of attachment methods, other than screws, can be used to attach the frame to the violin. The Frame connects to and grips the Violin at multiple points and therefore provides a stable platform to hold the Violin. The short arm [101] of the Frame connects to the Lower Bout of the violin with Feet [105] on either end of the short arm [101] at points very similar to how a shoulder rest is attached to a violin. The Feet [105] on the long arm of the T connects to the violin at the saddle. By adjusting the placement of the Frame along the violin, the Feet are placed such that the Violin is held securely.

The Frame can also be an X shaped structure that accommodates four Feet at each of the end points of the X. These four Feet connect to the Body of the violin at four different points creating a stable hold for the violin.

The Frame can also be of different styles and shapes that have multiple Feet to hold the Violin securely. In another implementation, FIG. 4, the Frame can be longitudinal along the Body of the violin with one of the Feet at the top next to the Button where the Tail Gut connects to the Tail Piece and another Leg at the upper bout near the saddle. The Frame can be a structure that holds the violin securely with two or more Feet. The Frame can also be an integral part of the Violin body and made as one unit.

At a convenient location on the Frame is a means to attach the Frame to the Connector [300]. This can be in the form of a well nut [109] that can be embedded in the Frame or can be built as an integral part of the Frame. The Connector allows a secure connection to the Stand and in one implementation, the Connector is simply a Shoe and plate combination typically used to connect a camera to a tripod. Here the Shoe is securely fastened to the Frame by means of a standard screw typically used in a tripod and will slide into a Quick Release Plate that is fixed to the Stand much like a camera would connect to a tripod. The Shoe could be of different sizes and shapes to enable easy and quick insertion into the Quick Release Plate of the Stand. The Connector and Frame could be joined together as one integrated unit (Integrated Frame). This Integrated Frame can be connected to the Stand in a manner that allows a quick and easy connection and removal, at the same time providing a stable platform for the violin while being played. In another implementation, the Connector is a Ball Head [300] that is typically used to connect cameras to tripods or monopods. The ball head [300] screws on to the Frame and in turn connects to the Stand.

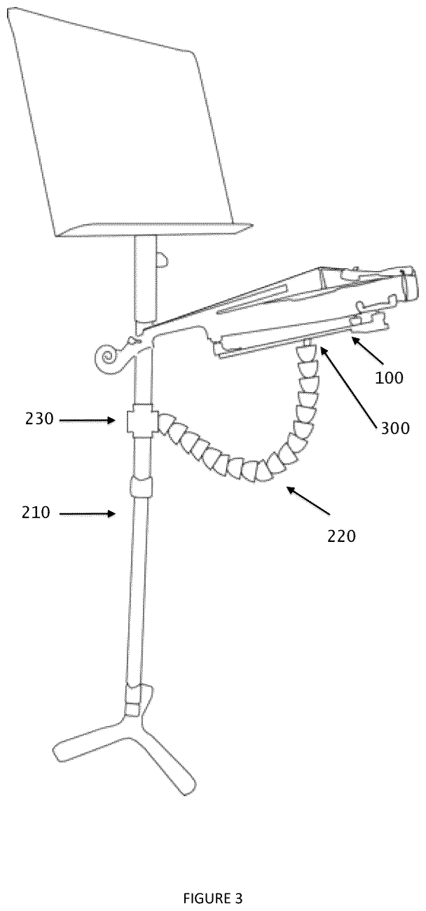

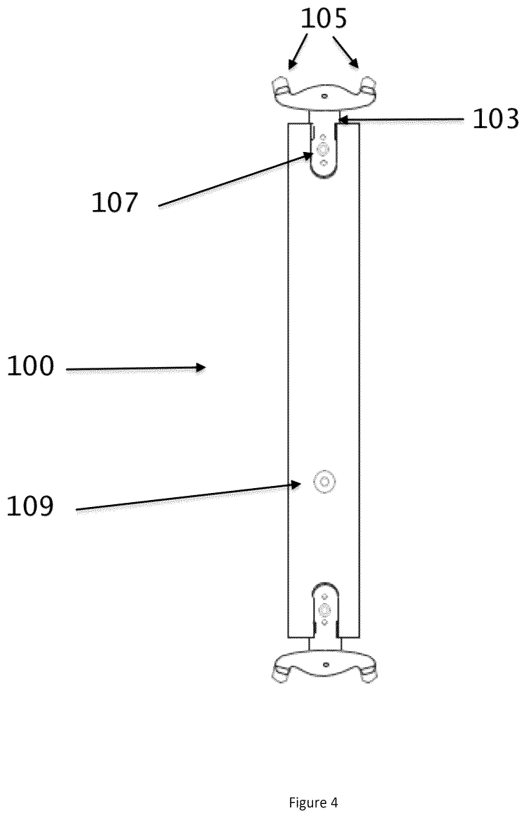

The Stand can be a basic Tripod that is typically used in photography for holding cameras in a stable manner. The Stand [200] shown here for reference is a monopod with foldable feet [205]. The Stand can also be of different types of tripods or monopods. The Stand can also be one similar to the ones used for holding sheet music with the Frame attached to it by means of a flexible arm, similar to the ones used in flexible lamps. This is shown in FIG. 3. Here the Tripod or Monopod is replaced by a flexible arm [220] that is connected to a music sheet music stand [210] by a connector that could be a clamp [230]. The flexible arm [220] can be adjusted to the appropriate height and position to accommodate the Violinist's seated or standing position.

Basically, the Stand can be any device that the Frame holding the violin can be attached to in a manner such that it is free standing and the violinist can play the violin comfortably without straining or engaging the neck.

Using the Violin Stand as described above, a violinist can secure the violin and play the violin comfortably without using their neck or shoulder. This overcomes the difficulties encountered by the traditional method and allows more people to enjoy playing the violin with a reduced barrier to entry.

Once the frame has been attached, the process continues with connecting the frame to a stand. The stand incorporates at least one adjustable support member along with a stable base assembly. The connection between the frame and the stand is achieved through an interface composed of interlocking components, sliding connectors, or a pivotally secured link. In certain embodiments, the frame includes a specially designed connection element—such as a mounting bracket or coupling member—that mates with a corresponding receptacle on the adjustable support member. This configuration ensures secure engagement while still permitting later adjustments.

Following the connection, the stand is adjusted to position the musical instrument for playing. The design of the stand allows modifications in several degrees of freedom, including height, pitch, roll, and yaw, which ensures that the instrument is properly oriented for the performer. These adjustments set the instrument at an optimal angle and distance so that performance occurs without relying on the traditional support provided by the player's shoulder or chin. The base portions and joints of the stand are engineered to provide stability during adjustments while resisting unintended movement during performance. The adjustment process incorporates locking mechanisms to secure the instrument at the desired position once the optimum configuration is achieved.

The materials selected for the frame and stand are chosen for their lightweight yet robust properties, ensuring durability without compromising the instrument's tonal qualities. Moreover, the configuration is designed to accommodate various types of musical instruments while maintaining the overall benefits of enhanced ergonomics and stable performance.

In one embodiment, the frame attaches to the musical instrument body by securing several feet at predetermined points on the body. The securing feet extend outward from the frame and are configured to engage corresponding attachment points on the instrument body, providing a mechanically secure and vibrationally stable connection. In certain embodiments, each securing foot includes a fastening interface, such as an aperture or a dedicated mounting surface, through which a fastener, clip, or adhesive is applied to join the frame to the instrument body. The fastener can incorporate screws, bolts, or other mechanical locking devices that interlock the securing feet at strategically distributed points along the body to evenly distribute mechanical loads and vibrations. In alternative embodiments, the securing feet incorporate one or more adhesive surfaces in combination with mechanical fasteners, creating an integrated bond that limits micro-movement between the frame and the instrument body.

The attachment process involves aligning the securing feet with corresponding recesses, apertures, or structural features on the instrument body and then applying a fastening mechanism that establishes either a permanent or semi-permanent bond. The distribution of the securing feet along the instrument body is designed to complement the instrument's contour and structural integrity, ensuring that mechanical stresses generated during performance are absorbed efficiently and that the overall stability of the instrument is maintained. For example, the securing feet are arranged so that at least three points around the periphery of the instrument body are engaged, thereby minimizing localized strain that could otherwise lead to deformations or unwanted vibrations.

In one embodiment, the frame consists of a first arm and a second arm connected by a joint configured to allow rotational movement. The joint provides a pivotal connection between the arms so they can be rotated relative to one another in order to adjust the frame's configuration to fit a music instrument body of varying shapes and sizes. For instance, the joint is designed to permit full or partial rotational movement, which enables the arms to be positioned at selected angles that optimize the engagement of the frame with the instrument body. In some embodiments the joint incorporates a frictional interface or a locking mechanism that enables the arms to be secured in a desired angular position once a proper fit has been achieved. The rotational adjustment of the arms facilitates the alignment of gripping surfaces or clamping features on the arms with complementary regions of the music instrument body, thereby improving stability and ensuring secure mounting of the instrument within the frame. The arms themselves are designed with extended planar sections that ensure an even distribution of forces when the frame is in use, and they also feature additional structural elements such as integrated set screws, detents, or other securing features that interact with the joint to maintain the adjusted position. In some implementations the rotation of the arms around the joint can be performed manually, while in alternative embodiments an actuator-driven mechanism is employed to provide motorized adjustment. The incorporation of such a rotatable joint renders the frame versatile and adaptable, ensuring that it can accommodate a range of instrument bodies by adjusting the relative orientation of the arms. Materials used for the construction of the arms and the joint include metals, polymers, or composite materials selected on the basis of strength, durability, and weight requirements. In certain embodiments the arms are configured with hollow portions for early routing of wiring or other elements associated with auxiliary functionalities. The overall design of the frame thus permits a customizable interface where the rotational adjustability of the arms plays an essential role in providing an optimal fit and balance between secure support and ease of installation on the music instrument body.

In one embodiment, a frame for a musical instrument is provided that incorporates a connector configured to slide onto a tripod or stand. The frame includes an attachment structure that is permanently or removably affixed to the instrument, and the connector is mechanically integrated with the frame to allow for a secure yet releasable engagement with the support structure. The connector comprises a cylindrical sleeve or similar structure sized and shaped to slide over a complementary cylindrical member of the tripod or stand. The interface between the connector and the supporting structure is designed to accommodate variations in diameter and surface finish typically encountered in commercially available supports, thereby enabling the connector to maintain a firm grip while allowing for easy installation and removal.

In one embodiment, the sliding connector incorporates one or more friction-enhancing features such as textured surfaces or resilient materials that provide a controlled resistance during the sliding action, ensuring that once the connector is in place, inadvertent displacement is minimized under normal operating conditions. Additionally, the connector includes a clamping mechanism or locking feature that engages once the connector has been slid onto the tripod or stand. This locking feature can be actuated manually or automatically, and it uses set screws, spring-loaded locking pins, or other comparable elements to secure the position of the connector relative to the support structure.

The design further contemplates that the connector could be formed as an integral part of the frame or as a separate component attached to the frame by mechanical fasteners or an adhesive bond. In either configuration, the sliding engagement provided by the connector allows for rapid assembly and disassembly of the instrument support system, facilitating ease of transport and setup.

In some embodiments, the connector is configured to permit slight angular adjustments after engagement with the tripod or stand, thereby enabling fine tuning of the instrument's orientation relative to the performance environment. This angular adjustment is achieved through a pivotal joint incorporated into the connector, which allows the frame to be rotated or tilted while the connector remains securely attached to the support.

Furthermore, the materials chosen for the connector and frame are selected to provide sufficient durability and structural integrity such that the system can reliably support the weight of the musical instrument under dynamic load conditions encountered during performance. Alternate embodiments incorporate additional features such as cushioning elements or vibration-damping materials at the interface between the connector and the tripod to reduce mechanical shock and improve overall stability.

In one embodiment, the musical instrument incorporates a structure configured so that its center of gravity aligns with a predetermined point defined relative to the instrument, the associated frame, and a connector. The instrument is engineered so that the mass distribution of its various elements—including but not limited to the body, the supporting or enclosing frame, and the connector that interfaces with additional components—produces a balanced assembly. This balance is achieved by strategically positioning the components relative to one another. For example, the frame is designed with specific contours or segments that redistribute mass toward the predetermined balancing point, which aligns with the geometric center of the instrument or shifts from the center to optimize performance or ergonomics. The connector is arranged to maintain a secure mechanical and functional coupling between the instrument and the frame, ensuring that forces applied to the connector do not disturb the overall mass equilibrium.

In alternative embodiments, the instrument incorporates adjustable weight elements that can be repositioned or fine-tuned during assembly or operation to compensate for variations in material distribution or changes in performance conditions. In these cases, the connector and the frame include features such as configurable mounting points, recesses designed to accept weight inserts, or mechanisms that allow for rotational or translational adjustment, all intended to ensure that the cumulative center of gravity of the instrument, frame, and connector stays aligned with the predetermined balancing point. The design also supports in situ adjustments, enabling the balance to be maintained dynamically during use. For instance, if the instrument experiences shifts in operational load or orientation, the structural relationship among the instrument body, the frame, and the connector is engineered to counteract these variations, ensuring consistent performance and handling characteristics.

In summary, by meticulously designing the placement and interconnection of the instrument, frame, and connector, the assembly achieves an optimal balance that enhances stability, ease of use, and overall functionality while accommodating a range of configurations and applications within the musical instrument domain.

In one embodiment, the frame attaches to the stand using a connector mechanism selected from a group consisting of a shoe and plate combination, a ball head, and an integrated connector. In embodiments using the shoe and plate combination, the frame includes a shoe component with a contoured surface and fastening apertures that align with a corresponding plate fixed to the stand. The shoe component is formed from a durable, robust material and shaped to complement the mating plate to provide a secure, stable interconnection. Fasteners, such as screws or bolts, are inserted through corresponding holes in the shoe and plate to lock the two components together, ensuring that the frame maintains the desired orientation relative to the stand while also enabling efficient load distribution and stress reduction.

In embodiments utilizing a ball head connector, the frame is affixed to the stand through a spherical joint that enables multi-directional movement or adjustment during assembly or operation. The ball head incorporates a spherical element received within a concave socket attached to either the frame or the stand, thereby providing a pivoting connection which allows for a range of angular adjustments. A locking mechanism, implemented using a clamp or a threaded lock, is provided to secure the ball head once the desired angular orientation has been achieved. This configuration permits both rapid alignment during installation and the ability to finely tune the angle between the frame and the stand while still maintaining a robust mechanical connection.

Each described connector embodiment offers distinct advantages based on application requirements. The shoe and plate combination provides reliable strength and ease of assembly, the ball head connector offers angular adjustability and convenience in orientation, and the integrated connector streamlines assembly with fewer separate components. In some embodiments, combinations of these connector types can be employed to utilize the unique benefits of each configuration, ensuring a robust, adaptable, and secure connection between the frame and the stand.

In one embodiment, the stand is configured as a tripod comprising three legs that extend outward from a central junction. The legs are adjustable in length individually, ensuring compensation for uneven ground or varying support requirements. The material selected for the tripod legs is chosen for its minimal weight while maintaining durability, and the connection between each leg and the central junction incorporates a locking mechanism that securely fastens the legs in a deployed position once adjusted. The tripod embodiment also includes pivot joints at the connection points to facilitate rapid reorientation when transitioning from a storage position to an operational state.

In another embodiment, the stand is realized as a monopod equipped with foldable feet. The monopod consists of a single elongated support member that functions to provide a stable vertical axis. The foldable feet attach via hinge or pivot mechanisms, allowing them to extend outwardly to form a base of support and ensure lateral stability during use. When not engaged, the foldable feet retract compactly alongside the monopod to facilitate ease of transport and storage. Secure locking arrangements are provided to maintain the feet in their deployed state during operation, ensuring that the support remains stable under various loading conditions.

In yet another embodiment, the stand includes a flexible arm that is removably coupled to a music stand. The flexible arm has multiple articulating joints that permit manual adjustment, thereby enabling precise control over the position and orientation of an attached device during use. The flexible arm is constructed as a series of interconnected segments which, when locked in a desired configuration, maintain rigidity and resist unwanted movement caused by external loads or vibrations. The coupling mechanism provided between the flexible arm and the music stand ensures that the arm detaches or repositions with ease, thereby accommodating differing use scenarios in both performance and practice settings.

In all embodiments, the design considerations for the stand are focused on providing a stable, adjustable, and easy-to-use support mechanism that can accommodate a range of applications. The various configurations—tripod, monopod with foldable feet, and flexible arm attached to a music stand—are intended to offer flexibility and adaptability for the user, with each embodiment incorporating features such as adjustable components and secure locking mechanisms that ensure stability during operation while also enabling efficient assembly, disassembly, and transport.

In one embodiment, the frame is constructed from a lightweight, rigid material selected from the group including plastic and wood. The plastic material consists of advanced polymers such as polycarbonate, polypropylene, or acrylic, which offer an advantageous combination of reduced mass and enhanced impact resistance while maintaining the rigidity required for structural stability. The wood material includes various species such as hardwood, engineered wood, or laminated veneers, chosen for their inherent strength and aesthetic qualities as well as their ability to be formed into precise configurations through conventional woodworking processes. In either instance, the specific material is selected based on its capacity to satisfy predefined criteria, including minimal density, exceptional structural rigidity, and the ability to sustain applied loads without significant deformation.

In some embodiments, plastic components are produced using injection molding, extrusion, or thermoforming techniques that achieve a precise degree of dimensional accuracy and repeatability in the final product. Similarly, wood components are fabricated through cutting, laminating, or pressing processes, with the natural grain structure optimized to provide additional directional strength and rigidity. The selected material is treated or enhanced with additives or coatings to further improve properties such as resistance to ultraviolet degradation, moisture absorption, or thermal expansion, ensuring durability and performance in demanding applications. The frame design incorporates features like structural reinforcements, interlocking joints, or pre-formed cavities intended for integrating other system components, all of which exploit the lightweight, rigid material to deliver a robust yet economical solution for the intended application.

In one embodiment, a music instrument is designed for use with a support frame and a stand that are configured to maintain the instrument in a stable, elevated position during performance. The instrument remains operable while being supported by the frame and stand, enabling the user to perform with the instrument securely held in place. The frame is constructed to receive the instrument in a manner that, when combined with the stand, positions it at an ergonomically optimal height relative to the user's playing position. In this configuration, the player's neck stays in a natural, relaxed state that minimizes undue strain during extended performance. The structural components of the frame include adjustable support members that pivot or slide to modify the instrument's angle so that it aligns with the natural curvature of the player's neck and shoulders. The stand incorporates height and angle adjustment mechanisms, such as telescoping elements or articulated joints, which work in tandem with the frame to ensure that slight alterations in the player's posture are accommodated without compromising the instrument's stability. In some embodiments, cushioning or shock-absorbing materials are integrated into the frame or stand at contact points with the instrument, further reducing the transmission of vibrations and enhancing player comfort. The seating geometry relative to the instrument support is designed to provide the player with an unobstructed line of sight to both the music instrument and any accompanying performance aids, ensuring that the musician can simultaneously manage instrument handling and attend to performance cues. This configuration accommodates a variety of musical styles and instrument types by providing an adaptable interface between the performer and the instrument, thereby allowing a broad range of dynamic play while keeping the player's neck comfortably aligned. The design guarantees that even during vigorous performance, the instrument remains securely positioned, permitting the musician to focus on musical output rather than on the stability or positioning of the instrument.

The apparatus provides a support system for a musical instrument that eliminates the need for the instrument to be rested on a player's shoulder or chin. In one embodiment, a rigid or semi-rigid frame is configured for attachment to a predetermined location on the body of the musical instrument. The frame is constructed of lightweight materials such as extra-strength polymers or aluminum alloys to ensure durability with minimal added weight. The attachment to the instrument's body is arranged so that the frame securely engages with the instrument without causing damage, and it can employ clamping mechanisms, adhesive interfaces, or other fasteners that maintain a stable connection while allowing for easy installation and removal.

A connector couples the frame to the stand, incorporating features such as pivot joints, adjustable linkages, or a ball-and-socket mechanism that facilitate a range of relative movements between the two components. This adjustability allows the musical instrument to be positioned at various angles and heights to suit the playing style or posture of different users. In some embodiments, quick-release mechanisms integrate into the connector design to enable rapid attachment and detachment of the instrument from the support system. Other embodiments include locking features that secure the connector in a fixed position once the optimal orientation is achieved. Furthermore, the connector provides damping or cushioning properties to absorb incidental shocks or vibrations that might otherwise interfere with performance quality.

One implementation is adaptable and can be modified to suit instruments of various sizes, shapes, and weights. Modifications include altering the dimensions of the frame or stand, selecting alternative materials to optimize durability or aesthetics, or incorporating electronic elements for automated adjustment or monitoring of the instrument's position. The design ensures that the mechanical loads imposed on the musical instrument are effectively supported by the apparatus, thereby preserving the instrument's structural integrity and performance characteristics. The apparatus addresses challenges associated with traditional methods of instrument support while providing a modular, versatile, and ergonomic alternative for musicians seeking enhanced performance adaptability and comfort.

In certain embodiments, the joint incorporates a friction mechanism or detent system that supplies sufficient resistance against inadvertent movement while enabling deliberate adjustment when required. The continuous or stepped rotational adjustment facilitated by the joint allows the frame to conform to non-uniform surfaces and curvatures, thereby securing the instrument in a way that minimizes vibrations and potential damage. The joint is commonly designed to be detachable or reconfigurable, which permits maintenance or replacement as necessary and supports customization of the frame to suit different instrument geometries.

Materials selected for the arms and joint include lightweight yet robust options—for example, reinforced polymers or metal alloys—ensuring that the frame remains durable and easy to handle. Structural support provided by the arms and the joint helps distribute clamping forces evenly across the instrument body, reducing the likelihood of localized pressure points that could adversely affect sound quality or instrument longevity. In addition, the design incorporates integrated alignment guides or markings that assist the user in achieving the optimal orientation of the arms relative to the instrument, thus promoting a secure yet unobtrusive fit.

Overall, the rotatable arms connected by the joint provide a versatile and adaptable framework that customizes the device to the unique profile of any music instrument body, enhancing both stability during use and ease of storage when adjustments are no longer required.

The connector is engineered to slide smoothly along a mating guide or track integrated into the frame and includes a friction-based sliding mechanism or a set of detents that provide multiple fixed positions. Once the desired balance is achieved, the connector stays securely in place. The materials selected for the connector—including durable metals or high-strength polymers—are chosen not only for their structural integrity but also for their ability to maintain a minimized overall weight, further contributing to an even distribution of mass across the assembly.

Additional embodiments describe the connector with a contoured or ergonomic profile, facilitating easy manipulation during installation onto or removal from the tripod or stand and enabling rapid adjustments required in dynamic performance settings. Furthermore, the connector incorporates locking mechanisms, such as a clamping device or threaded fastener, to ensure a secure fit once installed, preventing inadvertent movement during use.

The channel or guide integrated within the frame is dimensioned to allow unobstructed sliding while providing sufficient resistance to avoid excessive play, ensuring the center of gravity stays as intended. In some variations, the interface between the connector and the tripod or stand incorporates a surface treatment or textured finish to improve grip and reduce the risk of slippage.

Such design considerations serve to optimize the stability of the musical instrument support assembly, reducing the likelihood of tipping or imbalance during performance. The overall configuration permits a high degree of adjustability, allowing the assembly to adapt to a range of musical instruments with differing weight distributions and geometries, and providing a reliable solution where both balance and ease of assembly are essential factors.

In one exemplary embodiment the connector comprises a shoe and plate combination that provides a secure mechanical interface between components. In such embodiments the shoe is configured to interlock with a mating surface while the plate is adapted to distribute forces evenly across a broader area and includes openings for fasteners or alignment features. The shoe is dimensioned to slide into or onto an associated structural element, and the plate is subsequently secured to a complementary mating component, thereby ensuring both positional accuracy and robust load transfer.

In yet another embodiment the connector is an integrated unitary element with the component, eliminating the need for additional fasteners or assembly steps. This integrated design is achieved through molding or machining processes that form a continuous structure incorporating the connector directly into the overall device. The integrated connector is configured with features such as built-in alignment guides, cable routing paths, or seal elements to provide multifunctional capabilities while reducing potential failure points.

The tripod embodiment includes additional design features such as swivel mechanisms at the connection points of the legs with the central hub to enable minor adjustments in orientation, as well as adjustable leg lengths to provide uniform stability on uneven surfaces. The monopod embodiment further incorporates an adjustable central shaft that enables alterations in the height of the support member and incorporates shock absorption features to reduce vibrations during use. The flexible arm embodiment also integrates cable management systems and adjustable clamping mechanisms to secure the attached apparatus while permitting rapid repositioning.

The lightweight, rigid frame also features design modifications such as thicker sections at points of elevated stress or integrated mounting structures designed to support additional components, thereby ensuring that the overall design meets both performance and regulatory requirements for the intended use.

In one embodiment the frame is configured to attach to the musical instrument at the bottom bout and to a saddle of the instrument. The frame incorporates integrally formed mounting features that align with and engage the curved geometry of that region. A contoured engagement area is defined to mirror a complementary profile of the instrument's bottom bout, thereby ensuring that mechanical loads are distributed evenly across the attachment surface.

Alternatively, in some embodiments the frame is secured by a clamping mechanism that utilizes spring-loaded or ratchet components to engage both the bottom bout and the saddle, providing a dual-point locking arrangement that enhances stability while allowing quick attachment and detachment. The fastening elements are arranged in a manner that minimizes stress concentration on the instrument and preserves its acoustic integrity.

Moreover, a series of guide features and alignment markers can be incorporated into the frame design to facilitate proper seating on the designated attachment surfaces. These features are configured to ensure that the orientation of the frame precisely corresponds with the anatomical curvature of the bottom bout and the specific geometry of the saddle, thereby guaranteeing that any subsequent mechanical or acoustic components attached to the frame are optimally positioned relative to the instrument.

In certain embodiments, resilient buffers or vibration damping elements are provided at the interface between the frame and the instrument to absorb shocks and vibrations that could otherwise affect performance. These resilient elements are selected based on material properties that offer both flexibility and durability, contributing to reduced mechanical decoupling during dynamic use.

Furthermore, the configuration of the frame attachment contemplates an adjustable architecture wherein the positional relationship among the frame, the bottom bout, and the saddle is fine-tuned. Adjustment features, for example, include sliding joints or threaded fasteners that allow for incremental modifications in the frame's placement relative to the instrument. This adjustability ensures that the frame accommodates variations in instrument design and can be easily calibrated during installation to meet specific performance criteria.

Overall, the frame is designed not only to secure ancillary components to the instrument but also to provide reinforcement and stability by closely conforming to key structural features, specifically the bottom bout and the saddle.

The foregoing details a device to support a music instrument such as viola or violin in a manner that eliminates the above-mentioned problems such as neck strain, neurological problems, difficulties for beginners to learn the instrument and overall comfort to experienced violinists. The Violin Stand described here is free standing, stable and does not require the violinist to press down with the chin to one side or use the shoulder to support the violin. The violin can now be played while standing or sitting straight leaving the neck free to be in a comfortable position thus eliminating any strain and symptoms of Fiddler's Neck. The Stand can be made portable and flexible to suit the playing styles and favored positions of any violinist. The Stand can be used for violins, violas and other bow and string instruments that have been played typically with human support.

1. A method of supporting a music instrument for playing, comprising:
attaching a frame to a body of the music instrument;
adjusting the frame to position the music instrument for playing without requiring support from a player's shoulder or chin or neck.

2. The method of claim 1, wherein attaching the frame comprises securing feet of the frame to multiple points on the music instrument body.

3. The method of claim 1, wherein the frame comprises two arms connected by a joint, further comprising rotating the arms around the joint to adjust the frame's fit on the music instrument body.

4. The method of claim 1, comprising connecting a frame to the music instrument with a connector that slides onto a tripod or a stand.

5. The method of claim 4, comprising balancing the center of gravity at a point on the music instrument, the frame and the connector.

6. The method of claim 1, comprising connecting the frame to a stand by using a connector selected from the group consisting of a shoe and plate combination, a ball head, and an integrated connector.

7. The method of claim 6, wherein the stand is selected from the group consisting of a tripod, a monopod with foldable feet, and a flexible arm attached to a music stand.

8. The method of claim 1, further comprising adjusting the frame to accommodate different music instrument sizes.

9. The method of claim 1, wherein the frame is made of a lightweight, rigid material selected from the group consisting of plastic and wood.

10. The method of claim 1, further comprising playing the music instrument while it is supported by the frame and stand, with the player's neck in a comfortable position.

11. An apparatus for supporting a music instrument, comprising:
a frame configured to attach to a body of the music instrument; and
a connector coupling the frame to the stand, ;
wherein the frame, stand, and connector are arranged to position the music instrument for playing without requiring support from a player's shoulder or chin or neck.

12. The apparatus of claim 11, wherein the frame comprises two arms connected by a joint, the arms being rotatable around the joint to adjust the frame's fit on the music instrument body.

13. The apparatus of claim 11, wherein the frame comprises multiple feet configured to grip the music instrument at different points on the music instrument body wherein the feet are adjustable to accommodate different music instrument sizes.

14. The apparatus of claim 13, wherein the connector that slides onto a tripod or a stand.

15. The apparatus of claim 14, wherein the connector is located on the frame to balance the center of gravity of the music instrument, the frame and connector.

16. The apparatus of claim 11, wherein the connector is selected from the group consisting of a shoe and plate combination, a ball head, and an integrated connector.

17. The apparatus of claim 11, comprising a stand coupled to the frame and the frame is selected from the group consisting of a tripod, a monopod with foldable feet, and a flexible arm attached to a music stand.

18. The apparatus of claim 11, wherein the frame is made of a lightweight, rigid material selected from the group consisting of plastic and wood.

19. The apparatus of claim 11, wherein the frame is configured to attach to the music instrument at a lower bout and a saddle of the music instrument.

20. The apparatus of claim 11, wherein the frame is configured as an X-shaped structure with four feet, each foot positioned at an end point of the X and configured to connect to the body of the music instrument.
